(19) United States
(12) Patent Application Publication
(10) Pub. No.: US 2005/0177641 A1
(43) Pub. Date: Aug. 11, 2005

(54) Method and apparatus for limiting access to a storage system

(75) Inventor: Kenji Yamagami, Odawara-shi, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/759,581

(22) Filed: Jan. 16, 2004

(51) Int. Cl. G06F 15/16

(52) U.S. Cl. 709/229

(57) ABSTRACT

A storage network device responds in a positive or negative manner to a connection request from another storage network device, based on vendor or manufacturer-related information. In this way, subsequent communication can be prevented. This is advantageous for limiting access to a device by devices which are properly certified, or otherwise sufficiently tested, thus improving reliability and performance.

### BACKGROUND OF THE INVENTION

The present invention is related to computer storage and in particular to limiting access in computer storage systems.

Storage access protocols, such as fiber channel protocol (FCP), small computer systems interface (SCSI), and FICON, are open protocols; i.e., protocol specifications are publicly disclosed. This greatly facilitates the entry of vendors of storage systems into the storage area network (SAN) market. While the increased competition is generally beneficial to the user, the proliferation of products can prove to be somewhat less than beneficial. As the number of devices for network attached storage (NAS) systems and SANs increase, the greater the burden is to test a piece of equipment for compatibility with other devices. It takes more time to test, certify, and provide support for the various combinations of equipment. For example, a switching equipment manufacturer may have to certify its equipment with other switches, host bus adapters (HBAs), storage subsystems, and so on. Some vendors may curtail or simply bypass the testing and the end user is suddenly at risk of deploying uncertified or otherwise untested equipment. This can cause connectivity problem arising from incompatible operation between devices, improper hardware or software versions, and so on.

To avoid this problem, many vendors publish a list of supported vendors and firmware versions. For example, a storage system vendor provides its supporting HBAs and Fibre channel switches along with firmware versions. A user or system engineer simply checks the list to determine if certain equipment is supported or not. This can be a time consuming task for the administrator.

Also, in the rapidly changing business environment, companies sometimes ally with other companies in order to complement each other. It is a very common business strategy for a company to allow only strategic partners to connect to their networks. Such a strategy requires a technology to limit connection to the network only for strategic partners. Reconfiguring a network in this manner can be very time consuming and error prone work. Worse yet, if inapplicable devices are connected by mistake, the entire system may be taken down or, in the worst case, data may become corrupted.

### SUMMARY OF THE INVENTION

In accordance with one aspect of the invention, a storage network device responds in a positive or negative manner to a connection request from another storage network device, based on vendor or manufacturer-related information. In this way, subsequent communication with the storage network devices can be limited to those devices that are properly certified, or otherwise sufficiently tested.

### BRIEF DESCRIPTION OF THE DRAWINGS

Aspects, advantages and novel features of the present invention will become apparent from the following description of the invention presented in conjunction with the accompanying drawings:

FIG. 1A is a high level generalized block diagram of a storage network showing an embodiment of the present invention;

FIG. 1B is a high level generalized block diagram of another storage network showing another embodiment of the present invention;

FIG. 2 illustrates an example of an Access Control Table;

FIG. 3 is a flow diagram, highlighting the handling of a connection request according to an embodiment of the present invention;

FIG. 4A illustrates an example of a task set table;

FIG. 4B is a flow diagram, highlighting the handling of a request for service according to an embodiment of the present invention; and

FIG. 5 is a flow diagram, highlighting a process for updating an Access Control Table.

### DESCRIPTION OF THE SPECIFIC EMBODIMENTS

The hardware that connects workstations and servers to storage devices in a storage network is generally referred to as a “fabric,” or “switch fabric.” The fabric enables any-server-to-any-storage device connectivity through the use of Fibre Channel switching technology. The illustrative embodiments of the present invention disclosed herein discuss a Fibre Channel technology implementation. But it can be readily appreciated that other storage network technologies can be adapted to incorporate aspects of the invention.

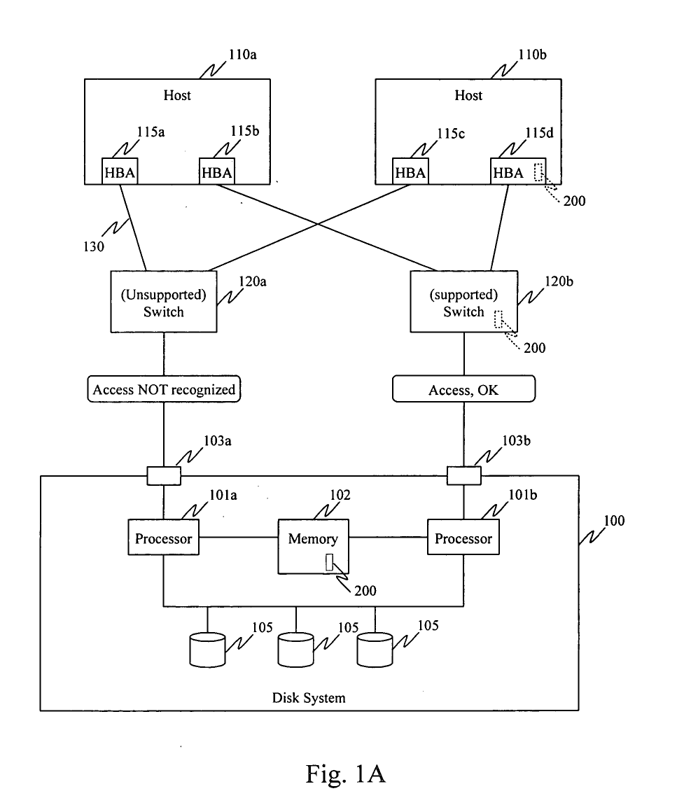

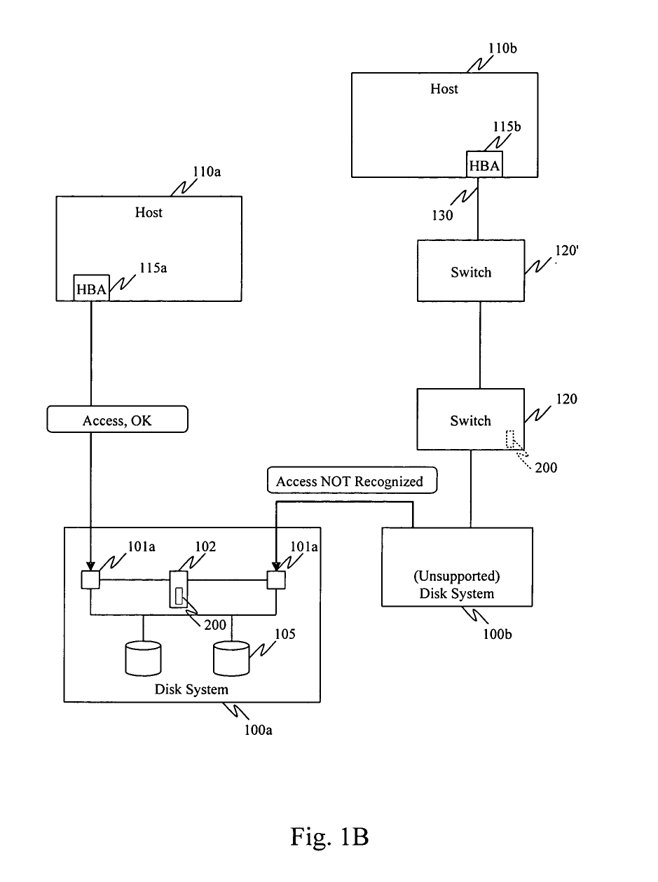

Referring to FIG. 1A, a high level block diagram of an example embodiment of the present invention showing a typical configuration of storage network devices. A disk system 100 comprises processors 101a, 101b. A memory component 102 is provided for the control program(s) which execute to operate the disk system. The memory component may also provide data caching for the plurality of disks 105 which constitute the storage component of the disk system. The processor 101a communicates with external devices via a communication port 103a. Similarly, processor 101b communicates via port 103b.

FIG. 1A also shows a plurality of switches 120a, 120b. Though two are shown, it is understood that a number of switches might be disposed between a host 110a and the disk system 100. Switches route data or information between hosts 110a and the disk system. Many kinds of switches are known; for example, fibre channel switches, InfiniBand® switches, and Network or Fibre channel Hubs or Routers represent a small sampling of switches.

The host 110a, on which a user's applications run, conventionally comprises processing components, memory, and so on (not shown). The host also includes host bus adapters (HBAs). The illustrative example of FIG. 1A shows HBAs 115a, 115b in host 110a. Host 110b comprises HBAs 115c, 115d. An HBA connects the host to an external device, such as a switch. The HBA can directly connect a host to the disk system, or to another host. Examples of HBAs include Fibre Channel HBA and a Network card. Application data stored to the disk system 100 can be accessed via a network 130 through an HBA. Instances of network 130 include Fibre channel, ESCON, FICON, TCP/IP, and SCSI.

FIG. 1B is a high level block diagram of another example embodiment of the present invention. The configuration shows two disk systems 100a, 100b, where disk system 100a and disk system 100b are connected for data communication. A host 110a is in data communication with disk system 100a. In the example shown in FIG. 1B, the host 110a is directly connected to the disk system via its HBA 115a. A host 110b is shown connected to a switch 120′. The switch is connected to a second switch 120. The second switch in turn is coupled to the disk system 100b. FIG. 1B illustrates that more than one switch can be disposed between endpoint nodes; e.g., host and storage.

In a conventional configuration, the disk system 100b can access disk system 100a. From the point of view of the host 110b, the host can only “see” disk system 100b. The disk system 100b can map logical drives accessible by the host 110b to physical drives location in the disk system 100a in a transparent manner, so that the host 110b does not need to know of the existence of the disk system 100a. Thus, when the host 110b issues commands to access the logical disk, the disk system 100b receives the commands and sends them to the disk system 100a to fulfill the request.

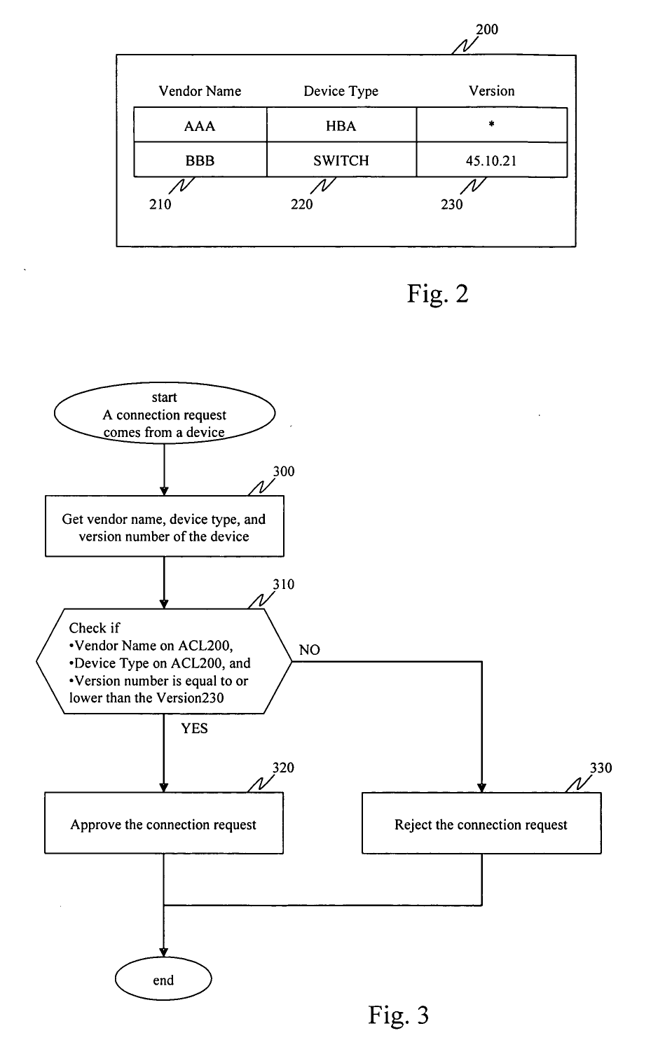

Refer now to FIG. 2 for a discussion of an Access Control Table, 200. The Access Control Table contains information that shows vendors and version numbers of devices authorized to access a target device. In the specific example shown in FIG. 1A, the target device is the disk system 100. Thus, the Access Control Table can be stored in the memory component 102, as indicated in the figure. The processors 101a, 101b can access and otherwise modify the table. In the example shown in FIG. 1B, the target device is the disk system 100a.

The table comprises a vendor field 210, a device type field 220, and a version field 230. The vendor field 210 identifies the vendor or a piece of equipment. The information in the vendor field can be alphanumeric such as the company name of the vendor. The information can be a code that in some way corresponds to a specific vendor; e.g., OUI (Organizationally Unique Identifier).

The device type field 220 contains information which identifies the type of equipment. FIG. 2 shows as examples, that the first entry in the table is for an HBA device supplied by company AAA. A second entry in the table identifies a switch supplied by company BBB. It can be appreciated that, if deemed necessary, the device type field can be expanded to more specifically identify different models of a particular kind of device supplied by a vendor. For example, vendor AAA may have many models of HBAs. The device type field can be expanded to accommodate the different HBAs, or additional fields in the Access Control Table 200 can provided.

The version field 230 includes version information associated with the device. It can be appreciated that, if needed, this field can be enhanced or otherwise expanded to include version information of components of a given device. For example, a switch may have a single version number that represents the entire switch. Another vendor, may provide a software version and a separate hardware version for its switch. The Access Control Table 200 can be expanded as needed to accommodate any such manufacturer-related information.

FIG. 3 is a flowchart highlighting processing in a device according to the invention, with reference to FIG. 1A. For the purposes of explanation, the particular configuration example illustrated in FIG. 1A assumes that switch 120a is unsupported by the disk system 100 (for example, it may be that the switch has not yet been certified for operation with the disk system). The flowchart shows the processing that takes place in the disk system 100. However, it can be appreciated from FIGS. 1A and 1B, that the process shown in the flowchart of FIG. 3 can be applied to any device in a storage network; e.g., HBA, switch, another disk system. FIGS. 1A and 1B illustrate this idea. The figures show that other devices in the storage network can be configured according to the present invention. Thus, switch 120b in FIG. 1A can include an Access control table (indicated in phantom lines); see also switch 120 in FIG. 1B.

Thus, the procedure begins when a connection request is received by a device. For example, in FIG. 1A, the switch 120a might receive a connection request from HBA 115a. Or, the switch 120b might make a connection request to the disk system 100. In this particular embodiment of the invention, a connection request between two nodes in a storage network is commonly referred to as “fabric login” (FLOGI). When the two nodes are endpoints (e.g., HBA to disk system), the connection request is referred to as a “port login” (PLOGI).

In a step 300, the device that receives the connection request obtains information associated with the request. For example, if the switch 120a or 120b sends a connection request to the disk system 100, the connection request may include information that represents the vendor, the device type, and version information of the switch. In the case of Fibre Channel, when the sending device (e.g., switch 120a or 120b) sends a connection request (i.e., FLOGI) to the disk system 100, the disk system can obtain the login parameters from the FLOGI request. Typical information includes a world wide name (WWN) representative of the vendor of the device(e.g., an OUI), the type of login (FLOGI, PLOGI), and vendor version level information, and so on. For example, vendor information of the requesting switch can be obtained from the connection request.

In a step 301, a comparison of any manufacture-related information that can be obtained in step 300 is made with information contained in the Access Control Table 200. If the receiving device that is processing the connection request (e.g., disk system 100) finds a sufficient match in the table for the sending device (e.g., switch 120b), then it will set its internal state to recognize the sending device and allow access (step 320). For example, the process can include searching the Access Control Table for an entry that matches an identifier of the vendor of the device. A comparison can be made to check that the version (e.g., software release, hardware version, etc.) is compatible for the receiving device.

The receiving device may have to provide a suitable positive response, depending on the specifics of the connection request protocol, to indicate to the sending device that the connection request was accepted. For the FLOGI command sequence, for example, if the disk system accepts the login request, it will return an accept (ACC) frame to the sending device.

If the sending device (e.g., switch 120a) is determined not to be in the Access Control Table, then the receiving device processing the connection request (e.g., disk system 100) will set its internal sate to not recognize requests from the sending device (step 330). A suitable negative response may be needed, depending on the specifics of the connection request protocol. The sending device (e.g., switch 102a) will detect the negative request and will not attempt to access the receiving device (e.g., disk system 100).

Some notation can be used in the Access Control Table 200 to indicate a “don't care” situation. For example, FIG. 2 shows an asterisk for the HBA device from company AAA. By convention, this can be taken to mean that the version number is irrelevant, and so no attempt to find a match for this field will be made. This feature may be useful where information for certain fields may not be available from the connection request. By specifying such fields to be “don't care,” a match can still be made on any information that can be obtained from the connection request.

The determination step 310 makes a determination of accessibility based on whether or not the sending device is listed in the Access Control Table. It can be appreciated that the Access Control Table can include information specifically indicating whether a sending device will have access to the device that is receiving the connection request.

It can be appreciated that the foregoing processing can be performed between any two devices. Thus, an HBA can attempt a connection request either directly to a disk system, or to a switch. One switch can make a connection request to another switch. A switch make a connection request to a disk system. As can be seen in FIG. 1B, a disk system can send a connection request to another disk system, in a suitable configured storage architecture. For example, the requesting disk (e.g., disk system 100b) might appear to the requested disk (e.g., disk system 100a) as a switch device making a connection request.

To complete the discussion of FIG. 1B, the figure illustrates that the disk system 100b sent a connection request to the disk system 100a. The disk system 100a obtained information from the connection request (step 300). A check (step 310) of an Access Control Table by the disk system 100a indicated that the disk system 100b was not listed in the table. Consequently, the disk system 100a responded to the connection request with a negative response (step 330). The effective result is that disk system 100b is invisible to disk system 100a. Similarly, disk system 100a appears not be accessible, from the point of view of disk system 100b with the effect that disk system 100b would not attempt to access disk system 100a.

In accordance with another aspect of the present invention, limited access to a device can be provided as an alternative to complete elimination of access to a device. The novel idea of “task sets” for a device will now be discussed. Each device provides a variety of services and functionality. For example, a disk system can perform functions such as:
Read and write a disk
Snapshot
Remote mirroring
Change LU configuration (e.g. change size, define access paths and LU number, etc)
Get internal performance and configuration data
Change subsystem operational mode
   The services or functions for a device will vary from vendor to vendor, and between models from a vendor. Typically, the interface to access these services is provided in the form of an API (application programmer's interface), CLI (command line interface), and/or GUI (graphical user interface). The commands can be communicated via the path 130 (FIG. 1A, for example). The internal implementation of these commands in a device are device specific and vendor specific. For example, a command might be mapped to a special SCSI command (vendor specific command out of definition of SCSI standard).

In accordance with an embodiment of this aspect of the invention, “task sets” can be defined from the full set of services and functions provided by a device. For example, the table below lists the services and functions for typical disk system (e.g., disk system 100, FIG. 1A):

TABLE I

| | Task |
|---|---|
| Task 0 | Reading a disk |
| Task 1 | Writing a disk |
| Task 2 | Operation on mirror. For example, create, suspend and delete |
| | a Snapshot or Remote Mirroring. |
| Task 3 | Reading a system configuration. For example, reading LU size, |
| | cache size, LU path information, performance information etc. |
| Task 4 | Setting a system configuration. For example, changing LU size, |
| | setting LU path, etc. |
| Task 5 | Changing subsystem operation mode |

A task set specifies the sets of tasks that a device (e.g., disk system 100) will permit for a given device that can access it. For example, with respect to FIG. 1A, a task set can be defined for switch 120b, allowing the switch to perform Task 1 and Task 3 on the disk system. With reference to FIG. 1B, a task set contained in the disk system 100a can be defined for HBA 115a, allowing the HBA to perform Task 3 on the disk system. It can be seen that a task set can contain one or more tasks.

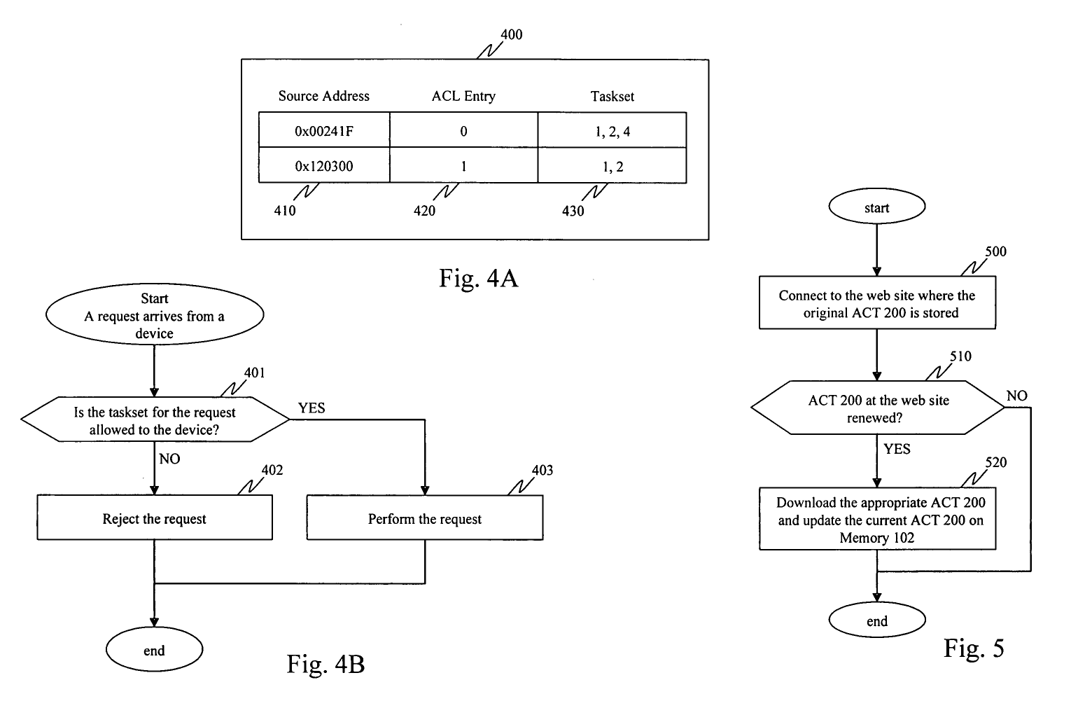

FIG. 4A shows a task set table 400 according to an illustrative embodiment of this aspect of the invention. As with the Access Control Table 200, the task set table can be provided in any of the storage network devices. The task set table comprises a source address field 410, an ACT entry field 420, and a task set field 430. The source address field 410 corresponds to the source address for a particular device. This is typically provided by a name server when a device first connects to the network. After a successful connection request is performed, subsequent communications typically include the address of the device sending a service request. For example, when a switch sends a service request to the disk system, the request includes a source address that is associated and identifies the switch. Therefore, the source address field can be used to identify the device that is sending a service request.

The ACT entry field 420, is an index or pointer to the Access Control Table 200. This field serves to relate the source address, which is simply a number, to an entry in the Access Control Table to identify the device associated with the source address. This field can be used to facilitate any maintenance activity on these tables that might be performed by an administrator.

The task set field 430 identifies the one or more tasks that a request-receiving device (e.g., disk system) will permit a sending device (e.g., switch, HBA) to perform. Thus, for example, a device having a source address of 0×00241F will be permitted to perform Tasks 1, 2, and 4. A device having a source address of 0×120300 will be permitted to perform Tasks 1 and 2.

FIG. 4B is a high level flow chart highlighting the processing that takes place on the task set table 400. For explanation purposes, it will be assumed that the disk system 100 (FIG. 1A) contains the task set table and will limit access to sending devices based on the task set table. It will be understood that the process described in the flowchart of FIG. 4B can be applied to other devices (e.g., HBA, switch).

Processing is invoked when the disk system 100 receives from a device (e.g., switch 120b) a request for a service, it will determine in a step 401 whether the service should be performed. This includes accessing the source address from the request, and finding a matching entry in the task set table using the accessed source address. If the address is not found, then the request is rejected, in a step 402. The specific response for “rejecting” the request will vary depending on the specific communication protocol being used.

If an entry for the source address is found, then the task set field 403 of the found entry is examined. The request is compared against the list of permitted tasks listed in the task set field 430. If the request is not listed in the task set field, then a negative response is produced, step 420. If the request is list in the task set field, then the requested service is performed. This may or may not include producing a response, depending on the service and the protocols in effect.

The Access Control Table 200 will periodically have be updated over time, as devices are tested and become certified. One method is to provide an interface on the device to allows administrative activity to be performed on the table. This interface can have the form of an API, or a user interface such as a CLI or a GUI. For example, consider that the Access Control Table is located in a disk system. An API can be provided that allows a GUI to be written in a host device that accesses the API. The API can provide functions to access and maintain the Access Control Table. The following table lists some typical administrative functions:

TABLE II

| Operation Name | Operation |
|---|---|
| Register Device | Register newly supported device. Input parameters are |
| | Vendor Name, Device Type and Version Number |
| Unregister Device | Unregister a deivce on ACL200. Input parameters are |
| | Vendor Name, Device Type and Version Number. |
| | Disk System 100 removes the matched entry from |
| | ACL200 |

It can be a rather laborious (and error-prone) task to manually update Access Control Tables. This can be especially tedious if many devices, including switches, HBAs, and disk systems, incorporate the present invention. Thus, in accordance with still another aspect of the invention, a central location such as a web site can be provided. The central location provides all the Access Control Tables for all devices of interest. A device configured according to the invention can be configured to periodically check the central location for updates and access an updated Access Control Table, if one is present.

The central location contains the following information to facilitate the update of an Access Control Table (ACT):
Version of ACT 200
It is used for Disk System 100 to compare ACT 200 at the web site is updated. Of course Disk System 100 stores version of ACT 200 along with ACT 200 to Memory 102.
Applied device for the ACT 200
If a vendor supply several types of devices (e.g. Disk System 100 and HBA115, etc.), then a different ACT 200 may be necessary for each device.

FIG. 5 shows a flowchart for updating the Access Control Table. A connection is made to the central location, step 500. In one embodiment of this aspect of the invention, a web site can be provided. The connection then comprises accessing the web site. The device whose ACT is to be update (e.g., disk system 100) checks if the web site contains an updated table, step 510. This can be done, for example, by downloading the table and comparing it with the version contained in the disk system. If it is determined that the table needs to be updated, then in a step 520 the old table is replaced with the newly downloaded table.

1. A method for processing service requests in a first device in a storage network comprising:
receiving a connection request from a sending device;
obtaining manufacture-related information associated with the sending device; and
responding to the sending device in a positive manner or in a negative manner based on a comparison of the manufacture-related information with manufacture-related information contained in an access control table,
wherein responding in a positive manner will permit subsequent data communication between the first device and the sending device,
wherein responding in a negative manner will prevent subsequent data communication between the first device and the sending device.

2. The method of claim 1 wherein the connection request is a fabric login, wherein the manufacture-related information includes information representative of the manufacturer of the sending device.

3. The method of claim 2 wherein the step of responding to the sending device includes determining whether the manufacturer is listed in the access control table.

4. The method of claim 3 wherein the manufacture-related information further includes version information, wherein the step of responding to the sending device further includes determining comparing the version information with version information in the access control table.

5. The method of claim 2 wherein the access control table includes access permission information associated with the manufacturer, wherein the step of responding to the sending device in a positive manner or in a negative manner is based on the access permission information.

6. The method of claim 1 wherein the first device is a disk system.

7. The method of claim 6 wherein the sending device is a host bus adapter (HBA).

8. The method of claim 6 wherein the sending device is a switch.

9. The method of claim 6 wherein the sending device is a second disk system.

10. The method of claim 1 wherein the first device is a switch and the sending device is an HBA.

11. The method of claim 1 wherein the first device is a first switch and the sending device is a second switch.

12. The method of claim 1 wherein the first device is an HBA.

13. An access method in a storage network comprising:
receiving a service request in a first storage network device, the service request originating from a second storage network device, the first storage network device being configured to perform a plurality of services;
obtaining identifying information from the service request that is representative of an identity of the second storage network device;
based on the identifying information determining which of the services are associated with the second storage network device;
if the service request is for a service that is associated with the second storage network device, then performing the service request; and
if the service request is not for a service that is associated with the second storage network device, the producing an appropriate negative response, thereby indicating to the second network storage device that the service will not be performed by the first storage network device.

14. The method of claim 13 wherein the first storage network device is a disk system.

15. The method of claim 14 wherein the identifying information is a source address contained in the service request.

16. The method of claim 13 wherein the first storage network device is a switch.

17. The method of claim 13 wherein the first storage network device is an HBA.

18. A storage network device configured to perform the method steps of claim 13.

19. The storage network device of claim 18 wherein the storage network device is a disk system.

20. The storage network device of claim 18 wherein the storage network device is a switch.

21. The storage network device of claim 18 wherein the storage network device is an HBA.

22. A storage network device comprising:
data processing component; and
a communication port in data communication with the data processing component, and operable for communication with a second storage network device,
the data processing component comprising a memory component, the memory component configured with an access control table, the access control table comprising manufacture-related information for a first plurality of storage network devices,
the data processing component configured to perform the method steps of:
exchanging data via the communication port, including receiving a connection request that was communicated from the second storage network device;
obtaining manufacture-related information relating to the second storage network device based on information contained in the connection request;
producing a response based on a comparison of the manufacture-related information relating to the second storage network device and manufacture-related information contained in the access control table, the response being a positive response or a negative response; and
exchanging data via the communication port to communicate the response to the second storage network device.

23. The storage network device of claim 22 wherein the connection request is one of a fabric login and a port login.

24. The storage network device of claim 22 wherein the comparison includes a comparison of a vendor identification relating to the second storage network device with a list of vendor identifiers in the access control table.

25. The storage network device of claim 24 wherein the comparison further includes a comparison of version information relating to the second storage network device with version information contained in the access control table.

26. The storage network device of claim 22 wherein the storage network device is a disk system.

27. The storage network device of claim 26 wherein the second storage network device is one of an HBA, a switch, and a second disk system.

28. The storage network device of claim 27 wherein the connection request is one of a fabric login and a port login.

29. The storage network device of claim 27 wherein the comparison includes a comparison of a vendor identification relating to the second storage network device and a list of vendor identifiers in the access control table.

30. The storage network device of claim 22 wherein storage network device is a switch.

31. The storage network device of claim 22 wherein storage network device is an HBA.

32. A storage network device comprising:
a data processing component;
a data storage component operably coupled to the data processing component; and
a communication port configured for communication with a second storage network device,
the data storage component operable to perform the method steps of:
receiving a connection request from the second storage network device, the connection request being a fabric login request or a port login request;
obtaining vendor identification information from the connection request;
producing a response based on the vendor identification information; and
sending the response to the second storage network device,
wherein if the response is a positive response, then subsequent communication between the storage network device and the second storage network device is possible,
wherein if the response is a negative response, then subsequent communication between the storage network device and the second storage network device is not possible,
wherein the subsequent communication comprises storage access requests for access to the data storage component.

33. The storage network device of claim 32 wherein the second storage network device is one of an HBA, a switch, and a disk system.
